(19) United States
(12) Patent Application Publication
(10) Pub. No.: US 2013/0342446 A1
(43) Pub. Date: Dec. 26, 2013

(54) IMAGE DISPLAY DEVICE, IMAGE DISPLAY SYSTEM INCLUDING THE SAME, AND METHOD FOR CONTROLLING THE SAME

(71) Applicant: Sharp Kabushiki Kaisha, Osaka (JP)

(72) Inventor: Shinsuke MURATA, Osaka-shi (JP)

(21) Appl. No.: 13/926,128

(22) Filed: Jun. 25, 2013

(30) Foreign Application Priority Data
Jun. 26, 2012 (JP) 2012-142707
Apr. 25, 2013 (JP) 2013-091941

(51) Int. Cl. G06F 3/041

(52) U.S. Cl. CPC G06F 3/041
USPC 345/156

(57) ABSTRACT

An image display device includes a display unit that displays images in page units and a memory which stores data, and flashes an import button displayed on the display unit upon receipt of image data, and in response to operation of the import button by a user, stores received image data on a virtual page in the memory corresponding to a blank page that is on display, stores the received image data on a virtual page in the memory corresponding to a blank page following the page on display, or stores the received image data on a virtual page in the memory secured as a new page following the page on display, after which the image display device displays the image data stored on the virtual page as an image on the display unit. This makes it possible to display the received image at a time specified by the user.

### BACKGROUND OF THE INVENTION

1. Field of the Invention

The present invention relates to an image display device which is preferably used in conferences, presentations, and the like and which displays images in page units and particularly relates to an image display device capable of displaying received images with user-specified timing, an image display system including the same, and a method for controlling the same.

2. Description of the Related Art

Devices having various configurations have recently been put to practical use as an electronic whiteboard, which is one example of a touch drawing image display device. Electronic whiteboard devices configured as a computer system by combining an image display device having a large display screen and an input device that detects two-dimensional position coordinates of a touch panel or the like have particularly been utilized. Large electronic whiteboard devices are used in presentations or the like.

In general, an electronic whiteboard device successively reads information about position coordinates designated by a stylus or the like and the amount of movement thereof, and displays traces of inputs on an image display device based on the read information. Consequently, an electronic whiteboard device performs actions of an electronic whiteboard, such as handwritten or touch inputs.

Furthermore, electronic whiteboard devices which are connected to a communication network and are capable of displaying received files are also known. For example, Japanese Patent Application Laid-Open Publication No. H8-55067 discloses an electronic whiteboard device that is connected to a network and configured such that when a file desired to be shared with another party in a conference is dragged to an application window (whiteboard window), the device determines whether or not it is a file that can be displayed on the electronic whiteboard (whiteboard window), and if it is a displayable file, the device automatically displays the image in this file and sends this image to the device of the other party. When display is not possible, the electronic whiteboard device sends this file along with application information or the like indicating the content of this file. If this file is displayable, the image is displayed on the device of the other party which has received the file, and if it is not displayable, an icon representing this file is displayed.

However, with the technology disclosed in Japanese Patent Application Laid-Open Publication No. H8-55067, file sharing between the concerned parties (between the specified devices) is a premise, and there is a problem in that receiving a file from a third party, such as a file transfer from general external devices, is not envisioned. Specifically, with the technology disclosed in Japanese Patent Application Laid-Open Publication No. H8-55067, when a device receives an image, the image is immediately displayed. Therefore, even in cases where an image file from an external device is received while a presenter is giving a presentation by operating the display device connected to a network, the image is immediately displayed in the same way, thus causing the problem of interfering with the presentation.

Moreover, the technology disclosed in Japanese Patent Application Laid-Open Publication No. H8-55067 has a problem in that the received image is displayed so as to be superimposed on an object, such as a diagram drawn during the presentation. In order to display the received image so as not to be superimposed on an object being displayed, it is necessary to designate the display position for the received image on the screen or other such operation of securing the display area, thus making such operation cumbersome for the user.

### SUMMARY OF THE INVENTION

Accordingly, preferred embodiments of the present invention provide an image display device capable of displaying a received image with user-specified timing without being superimposed on an object that is on display, an image display system including the same, and a method for controlling the same.

An image display device according to an aspect of a preferred embodiment of the present invention displays images in virtual page units configured in a memory. The image display device includes a display unit that displays an image, a virtual page control unit having in the memory the function of configuring virtual page(s) and the function of storing image data in virtual page units, a reception unit that receives data, and an input unit that accepts a command to use the display unit to display data received by the reception unit as an image. The virtual page control unit includes a securing unit that secures in the memory a virtual page that contains no object and stores image data based on the data received by the reception unit on the virtual page that contains no object in response to the receipt of the command by the input unit. The display unit displays as an image the image data written to the virtual page storing the image data based on the data received by the reception unit.

Consequently, when the image display device receives data from outside, the received data can be displayed without being superimposed on a page that is on display by storing the received data on a virtual page newly stored in the memory as a blank page. In addition, it is possible to prevent the received data from having any effect on image data originally used in a conference, presentation, or the like. Furthermore, if the image display device is set so as to indicate only the receipt of data from outside, for example, it is possible to prevent interference with the progress of a conference, presentation, or the like. Because the presenter can display the received data by requesting to display when he or she wants to display the received data, the need for cumbersome operations for displaying the received data is eliminated.

The image display device preferably further includes a determination unit that determines, before a virtual page that contains no object is secured by the securing unit, whether or not the configured virtual page(s) contain(s) an object to be displayed as an image by the display unit. In response to the receipt of a command by the input unit, the determination unit determines whether or not the virtual page corresponding to the image that is on display by the display unit contains an object. Depending on the result of the determination by the determination unit, the virtual page control unit stores image data based on the data received by the reception unit on the virtual page corresponding to the image that is on display, stores image data based on the data received by the reception unit on the virtual page corresponding to an image to be displayed following the image that is on display, or stores image data based on the data received by the reception unit on a virtual page newly secured by the securing unit as a region corresponding to an image to be displayed following the image that is on display.

Thus, by determining the presence or absence of a virtual page in the memory corresponding to a blank page, the received image data can be stored on a virtual page corresponding to the existing blank page, such that the memory can be used efficiently. Moreover, the received image data can be added at any time during the course of the presentation.

In response to the determination by the determination unit that the virtual page corresponding to the image that is on display contains no object, the virtual page control unit more preferably stores image data based on the data received by the reception unit on the virtual page corresponding to the image that is on display.

Consequently, if a blank page is currently displayed, the received data can be displayed immediately without switching pages.

In response to the determination by the determination unit that the virtual page corresponding to the image that is on display contains an object and also the determination that the virtual page corresponding to the image following the image that is on display contains no object, the virtual page control unit even more preferably stores image data based on the data received by the reception unit on the virtual page corresponding to the image following the image that is on display.

This makes it possible to avoid any changes being made to data of the currently displayed non-blank page.

The image display device preferably further includes a determination unit that determines, before a virtual page that contains no object is secured by the securing unit, whether or not the configured virtual page(s) contain(s) an object to be displayed as an image by the display unit. In response to the receipt of a command by the input unit, the determination unit determines whether or not the virtual page corresponding to the image that is on display by the display unit contains an object. Depending on the result of the determination by the determination unit regarding all of a plurality of the virtual pages, the virtual page control unit stores image data based on the data received by the reception unit on the virtual page which stores data to be displayed as an image following the data to be displayed as an image at the end, out of the data stored on the virtual pages that have been determined to contain objects, or stores image data based on the data received by the reception unit on a virtual page newly secured by the securing unit (as a region for storing data to be displayed as an image) following the data to be displayed as an image at the end, out of the data stored on the virtual pages that have been determined to contain objects.

Thus, by adding a virtual page behind all of the data used in a conference, presentation, or the like and storing the received data thereon, it becomes easier to determine or confirm only the received data after the presentation or the like. In particular, when data of a plurality of images is received, the data can be stored altogether at the end, so determining or confirming the received data becomes even easier. In addition, if there is a blank page behind all of the data used in a conference, presentation, or the like, the received data is stored on this blank page without adding a virtual page, so the memory can be used efficiently.

In response to the fact that the data received by the reception unit contains a consolidation condition for consolidating and displaying a plurality of images in one page, the display unit more preferably displays image data based on the data that is to be displayed on the display unit as a plurality of pages of images and that is received by the reception unit on the display unit as images in accordance with the consolidation condition.

Consequently, when the number of received images is large and also there is no problem with reduced display, the received data is displayed in a consolidated manner, which eliminates or reduces the need for page operations, so this is efficient.

The image display system according to another aspect of a preferred embodiment of the present invention includes any of the aforementioned image display devices and a portable terminal device capable of communicating with the image display device. The portable terminal device sends data to the image display device.

This makes it possible to exhibit effects similar to the respective effects described above.

The control method according to a further aspect of a preferred embodiment of the present invention is a method for controlling an image display device including a display unit that displays an image, a memory that stores data, and a reception unit that receives data. This control method includes a step of configuring virtual page(s) in the memory, a step of accepting a command to use the display unit to display data received by the reception unit as an image, and a step of securing a virtual page that contains no object in the memory. This control method also includes a step of storing image data based on the data received by the reception unit on the virtual page that contains no object in response to the receipt of the command. This control method further includes a step of displaying as an image the image data written to the virtual page storing the image data based on the data received by the reception unit.

With this method, if a condition to be satisfied by a virtual page on which the received data is stored is appropriately set in the same manner as described above, depending on the state of the virtual page(s) configured in the memory when the image display device receives data from outside, the received data can be displayed after first being temporarily stored on an appropriate virtual page (either the existing virtual page or a newly added virtual page). Therefore, if the image display device is set so as to indicate only the receipt of data from outside, it is possible to prevent an obstruction to the progress of a conference, presentation, or the like. Furthermore, the received data is displayed simply by giving an instruction to display the received data, so cumbersome operations for displaying the received data become unnecessary.

With various preferred embodiments of the present invention, when the image display device receives data from an external device in a conference, presentation, or the like, it is possible to indicate only the receipt thereof, so the effect on the conference, presentation, or the like can be significantly reduced or prevented. Moreover, the presenter can display the received data as an image as needed at a desired timing depending on the preferences of the presenter or attendees, or the progress or status of the conference, presentation, or the like, for example.

In addition, when the received image is to be displayed, the received image data is stored on a virtual page containing no object or a newly secured virtual page and therefore displayed without being superimposed on a page that is on display and that contains an object, so there is no effect on the image data used in the conference, presentation, or the like.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing the configuration of the image display system according to a preferred embodiment of the present invention.

FIG. 2 is a block diagram showing a schematic configuration of the image display device shown in FIG. 1.

FIG. 3 is a diagram showing an example of the display screen of the image display device shown in FIG. 1.

FIG. 4 is a block diagram showing a schematic configuration of the terminal device shown in FIG. 1.

FIG. 5 is a flowchart showing the control process of a program executed in the image display device shown in FIG. 1 and used to display a received image.

FIG. 6 is a diagram showing the position in which a received image is disposed with respect to a series of pages of images to be displayed on the image display device.

FIG. 7 is a flowchart showing the control process of a program (different from the one in FIG. 5) executed in the image display device and used to display a received image.

FIG. 8 is a flowchart showing the control process of a program (different from those shown in FIGS. 5 and 7) executed in the image display device and used to display a received image.

FIG. 9 is a flowchart showing the control process of a program (different from the ones in FIGS. 5, 7, and 8) executed in the image display device and used to display a received image.

FIG. 10 is a diagram showing the position in which a received image is disposed with respect to a series of pages of images to be displayed on the image display device when the program in FIG. 9 is executed.

FIG. 11 is a diagram showing the position in which a received image is disposed with respect to a series of pages of images to be displayed on the image display device when the program in FIG. 9 is executed.

FIG. 12 is a diagram showing the position in which a received image is disposed with respect to a series of pages of images to be displayed on the image display device when the program in FIG. 9 is executed.

FIG. 13 is a flowchart showing the control structure of a program (different from those shown in FIGS. 5 and 7 through 9) executed in the image display device and used to display a received image.

FIG. 14 is a diagram showing the position in which a received image is disposed with respect to a series of pages of images to be displayed on the image display device when the program in FIG. 13 is executed.

FIG. 15 is a diagram showing the position in which a received image is disposed with respect to pages of images to be displayed on the image display device.

FIG. 16 is a diagram showing an example of a screen for setting the display mode.

FIG. 17 is a flowchart showing the control process of a program (different from those shown in FIGS. 5, 7 through 9, and 13) executed in the image display device and used to display received images.

FIG. 18 is a diagram showing examples of pages displayed on the image display device when the program in FIG. 17 is executed.

FIG. 19 is a diagram showing an example of a screen displaying a button for returning to the first page.

FIG. 20 is a block diagram showing the configuration of a system different from the one in FIG. 1.

### DETAILED DESCRIPTION OF THE PREFERRED EMBODIMENTS

In the following description of preferred embodiments of the present invention, the same reference numbers are assigned to the same components. The names and functions thereof are also the same. Therefore, a detailed description of these components will not be given.

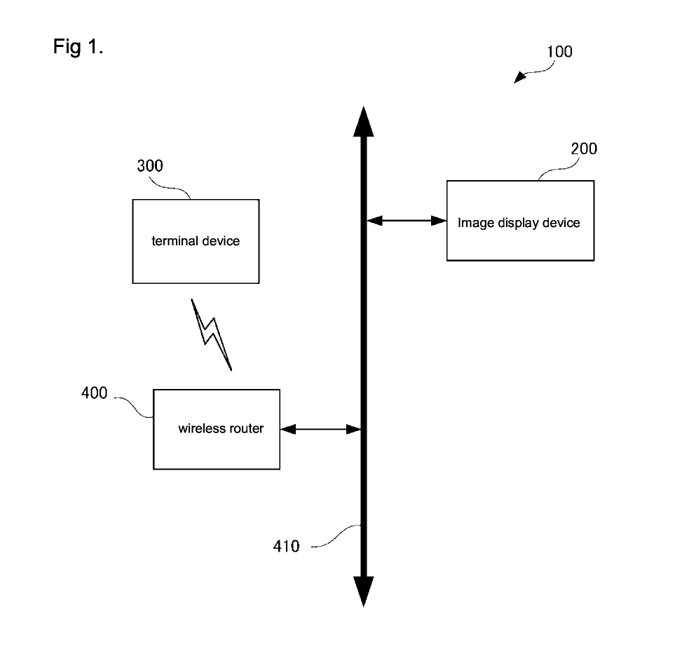

Referring to FIG. 1, the image display system 100 according to a preferred embodiment of the present invention preferably includes an image display device 200, a terminal device 300, and a wireless router 400. The image display device 200 and the wireless router 400 are connected preferably by a cable to a communication network (hereinafter referred to simply as “network”) 410, preferably including a LAN and/or Internet, for example. For example, the image display device 200 is a large-screen electronic whiteboard device capable of drawing by a touch operation. The terminal device 300 is a portable terminal device. Examples of the terminal device 300 include a tablet device including a display screen of approximately 10 inches and a smartphone including a display screen that is smaller in size (approximately several inches) than a tablet device.

The wireless router 400 is a device that connects devices having wireless communication capabilities to the network 410 in accordance with a specified communication protocol such as TCP/IP. The terminal device 300 can be connected to the network 410 via the wireless router 400. Note that terminal devices capable of wireless communication other than the terminal device 300 may be present in some cases around the image display system 100 though not shown in FIG. 1.

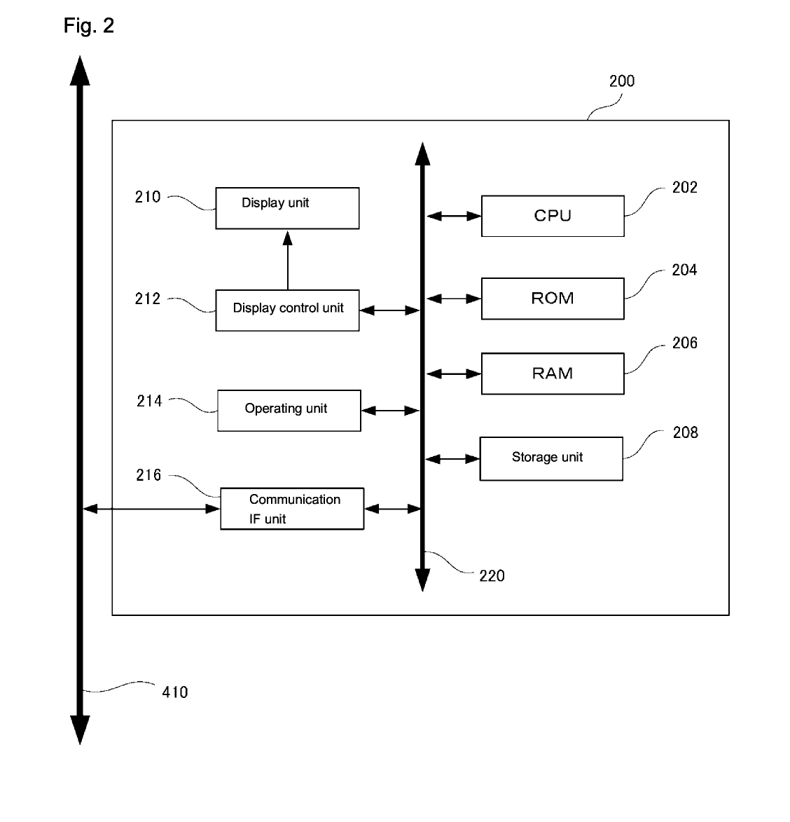

Referring to FIG. 2, the image display device 200 includes a control unit (hereinafter referred to as “CPU”) 202 that controls the image display device 200 overall, ROM (read-only memory) 204 to store programs and the like, RAM (random access memory) 206 which is a volatile storage device, a storage unit 208, and bus 220. The ROM 204 stores data and a program required to control the actions of the image display device 200. The storage unit 208 is a nonvolatile storage device that holds data even when power is cutoff, and examples include a hard disk drive and a flash memory. The storage unit 208 may be provided with a specified interface (such as USB) and configured in a detachable manner.

The CPU 202, the ROM 204, the RAM 206, and the storage unit 208 are connected to the bus 220. Exchange of data (including control information) between the respective units is performed via the bus 220. The CPU 202 reads a program from the ROM 204 onto the RAM 206 via the bus 220 and executes the program using a portion of the RAM 206 as the work region. That is, the CPU 202 controls the various units configuring the image display device 200 in accordance with the program stored in the ROM 204 and realizes various functions of the image display device 200.

The RAM 206 is provided with a function as a video memory to display images. That is, a portion of the RAM 206 is used as VRAM (video random access memory). Hereinafter, the region of the RAM 206 used as VRAM is referred to as a VRAM region. Note that a configuration is also possible in which VRAM is provided separately from the RAM 206.

The image display device 200 also preferably includes a display unit 210, a display control unit 212, an operating unit 214, and a communication IF unit 216. Here, a description will be given with an assumption that the image display device 200 is an electronic whiteboard device.

The display unit 210 is a display panel (such as a liquid crystal panel) to display images. The display control unit 212 is provided with a drive unit to drive the display unit 210, reads image data stored in the VRAM region of the RAM 206 at a specified timing, generates a signal to display the data as an image on the display unit 210, and outputs it to the display unit 210. The image data to be displayed is read from the storage unit 208 and transmitted to the RAM 206 by the CPU 202. Thus, the data stored in the VRAM region is displayed on the display unit 210 as an image.

The communication IF unit 216 is an NIC (network interface card), for example, and it is connected to a hub (not illustrated) or the like by communication cable and connected via the hub to the network 410. Consequently, image data is sent and received between computers or the like connected to the network 410. The image data received from outside via the communication IF unit 216 is recorded in the storage unit 208.

The operating unit 214 accepts input of a command or the like to the image display device 200 from the user. In an electronic whiteboard device, the operating unit 214 is disposed on the display unit 210 preferably defined by a liquid crystal panel or the like and includes an operation key unit and a touch detection device (neither of these are illustrated) having LEDs or the like to detect a touched position. Software keys (hereinafter also referred to as “softkeys”) are displayed on the display unit 210 in order to operate the image display device 200, and hardware keys (hereinafter also referred to as “hardkeys”) are disposed on the operation key unit. The CPU 202 monitors user's operations of these keys. The user can touch these keys to input commands in order to process the contents of display into the image display device 200. The selection of a softkey displayed on the display unit 210 is performed by detecting the touched position via the touch detection device.

The touch detection device preferably is a publicly known touch panel of infrared-light-blocking detection type, for example. The touch panel preferably includes rows of light-emitting diodes (hereinafter noted as “LED rows”) disposed in a single row each on two adjacent sides of the rectangular or substantially rectangular writing screen and two rows of photodiodes (hereinafter noted as “PD rows”) disposed in a single row each so as to face the respective LED rows, for example. Infrared light is emitted from each of the LEDs in the LED rows, and each of the PDs in the opposing PD rows detects the infrared light.

When the user touches a single point on the touch panel with a touch pen, infrared light is blocked by the tip of the touch pen. Therefore, the coordinate of the touched position can be determined. Even when the touch detection device is touched by a finger without using a touch pen, it is possible to detect the touched position in a similar manner.

The technology involving the detection of the touched position is publicly known, so no further explanation will be repeated. In addition, a touch panel other than of the infrared-light blocking type (such as an electrostatic capacitance type, a surface acoustic wave type, and a resistance film type) may also be used for the touch detection device, for example.

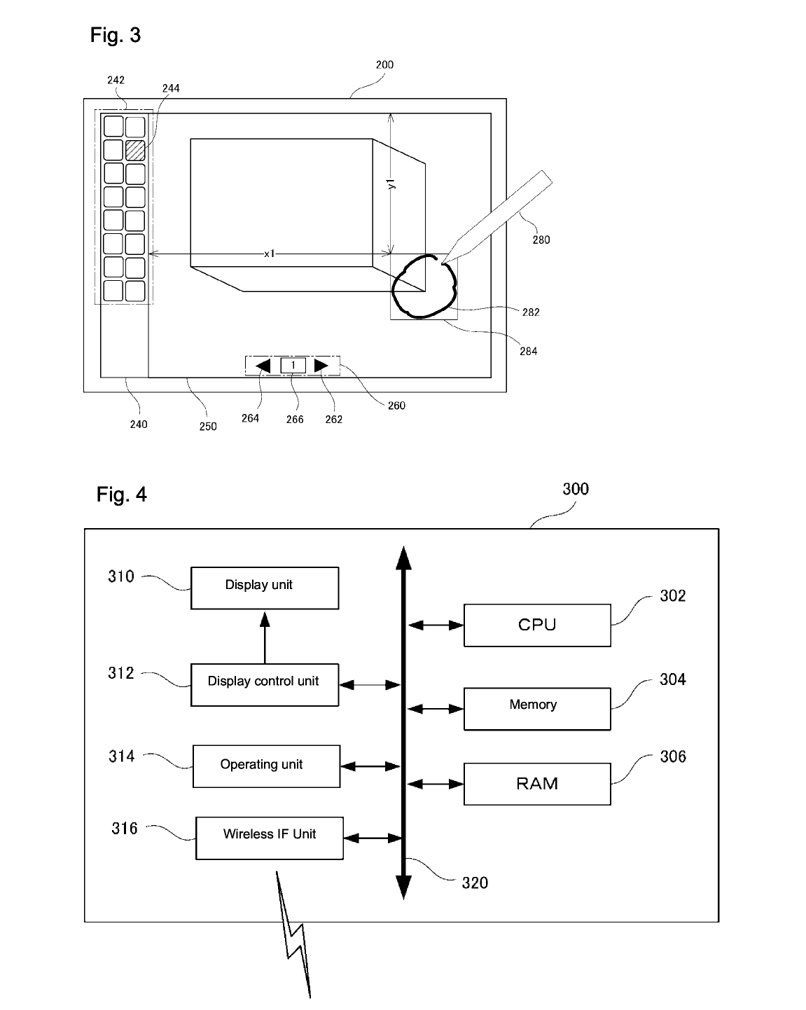

The image display device 200 displays a screen such as that shown in FIG. 3. The display screen of the display unit 210 is preferably divided into a drawing area 250 and a function button area 240. The drawing area 250 is an area in which the user can draw via a touch operation. Specifically, the XY coordinate of the touched point and the movement trace thereof are detected by the touch detection device as described above and transmitted to the CPU 202. The CPU 202 writes specified values according to the received coordinate data in a corresponding memory address in the RAM 206. The pixel values of image data on the VRAM region of the RAM 206 may be changed, but here, it is assumed that the RAM 206 is provided with a region storing drawing data (hereinafter also referred to as “overlay region”) separately from the VRAM region storing the displayed image data. In this case, if data of the memory address with no drawing in the overlay region is designated as “0,” for example, the CPU 202 writes “1” in the memory address corresponding to the drawn position. The display control unit 212 displays the image data (data on the VRAM region) and the drawing data (data in the overlay region) in a superimposed manner on the display unit 112. Specifically, the drawing data is displayed (e.g., a preset color is displayed) at points at which the drawing data exists (e.g., pixels in which “1” is recorded in the overlay region), while the image data is displayed at points at which no drawing data exists (e.g., pixels in which “0” is recorded in the overlay region). In FIG. 3, a FIG. 282 that is drawn with a touch pen 280 is displayed upon an image displayed in the drawing area 250.

The figure drawn in the drawing area 250 is managed as an object. Image data of a rectangular area circumscribing the drawn figure, for example, is stored in the RAM 206. With the FIG. 282, image data inside a rectangle 284 containing the circumference of the FIG. 282 is stored in a specified region of the RAM 206. The image data inside the rectangle 284 is data inside the overlay region, for example, and is image data which is such that the pixel value on the drawn line is a value other than “0” (such as “1”), while the pixel value of the other is “0” (binary image data). In addition to the image data inside the rectangular area, the information about the object includes information specifying the object (such as the name) and position information of the rectangular area. If the image data inside the rectangular area includes information about vertical and horizontal pixel sizes, then it is only necessary for the position information to be the position information of a point representing the rectangular area. For example, with the upper-left vertex of the drawing area 250 being the origin, the rightward direction being the positive direction of the X axis, and the downward direction being the positive direction of the Y axis, the position information is the XY coordinate of the upper-left vertex of the rectangular area ((x1, y1) with regard to the rectangle 284).

In order to display a drawn figure of a plurality of colors at the same time, it is only necessary to set the values of each pixel of the overlay region to 2 bits or more and to prepare a lookup table specifying a color corresponding to the values of each pixel of the overlay region.

The object is not limited to a drawn figure. An image read from an image file stored in the storage unit 208, written in the RAM 206, and displayed on the display unit 210 by the operation of function buttons is also managed as an object. The size of a read image is arbitrary, and if it is larger than that of the drawing area 250, it is reduced as needed and displayed.

Objects such as drawn figures may be stored in a form other than image data. For instance, it is also possible to store the coordinates (x, y) of the pixels on the drawn lines (i.e., the pixels having the value other than “0” in the overlay region).

As will be described later, an object is stored with correspondence being made to the page on which this object is to be displayed. Note that in the present specification, a “page” indicates an image produced from image data and presented in a visually recognizable state (e.g., the color and brightness of a two-dimensional pattern). Accordingly, information specifying an object is stored in the RAM 206 with correspondence being made to information specifying the page (such as the page number).

A plurality of function buttons (see one-dot-chain-line area 242) each assigned a specific function are displayed in the function button area 240. Examples of functions assigned to the respective function buttons include a drawing function by a touch operation, an eraser function that erases drawing of a specified area, a function of opening a file (image data) saved in the storage unit 208, a function of saving displayed image data in the storage unit 208, and a function of printing the displayed image data. Each function button is displayed as an icon. Thus, the various function buttons include icons giving instructions to perform image processing on the displayed image. An import button 244, which is one of the plurality of function buttons, is a button for importing image data received via the network 410. A detailed description of the import button 244 will be given later.

A page operation area 260 is displayed in the lower portion of the drawing area 250. A page forward button 262, a page return button 264, and a page number display field 266 are displayed in this area. The page forward button 262 is a button for sending the displayed page (image displayed in the drawing area 250) to the right side when touched and displaying the next page. The page return button 264 is a button for sending the displayed page to the left side when touched and displaying the previous page. The page number display field 266 displays the page number of the currently displayed page out of the plurality of displayable pages. The page operation area 260 has its position fixed and does not move even while scrolling. It is sufficient if data for displaying the page operation area 260 on the display unit 112, for example, is stored in an overlay region different from the overlay region for drawing.

When the user touches the page forward button 262, the coordinate data of the touched position is transmitted from the touch detection device to the CPU 202, and the CPU 202 determines that the received coordinate data is in a position inside the area where the page forward button 262 is displayed. If it is assumed that data of a series of images to be displayed is all read in advance from the storage unit 208 and stored in the RAM 206, from the image data in the RAM 206 corresponding to the currently displayed page and the image data corresponding to the next page, the display control unit 212 generates image data in the process of the page forwarding (image data for one page) and overwrites it in the VRAM region. Consequently, an image in the process of page forwarding is displayed on the display unit 112.

Referring to FIG. 4, the terminal device 300 preferably includes a CPU 302 that controls the terminal device 300 overall, memory 304, RAM 306, and bus 320. The memory 304 is an electrically rewritable nonvolatile storage device and is flash memory, for example. The memory 304 stores data and programs necessary to control the actions of the terminal device 300.

The CPU 302, the memory 304, and the RAM 306 are connected to the bus 320. Exchange of data (including control information) between the various units is performed via the bus 320. The CPU 302 reads a program from the memory 304 onto the RAM 306 via the bus 320 and executes the program using a portion of the RAM 306 as the work region. That is, the CPU 302 performs control of each unit configuring the terminal device 300 in accordance with the program stored in the memory 304 and realizes each function of the terminal device 300.

The terminal device 300 further includes a display unit 310, a display control unit 312, an operating unit 314, and a wireless IF unit 316. Here, a description will be given with an assumption that the terminal device 300 is a tablet device.

The display unit 310 is a display panel (such as a liquid crystal panel, for example) that displays images. The display control unit 312 is provided with a drive unit to drive the display unit 310, reads image data stored in the RAM 306 at a specified timing, generates a signal to display the image data as an image on the display unit 310, and outputs it to the display unit 310. The image data to be displayed is read from the memory 304 and transmitted to the RAM 306 by the CPU 302. The wireless IF unit 316 makes the connection of the terminal device 300 to the network 410 possible by performing wireless communication with the wireless router 400.

The operating unit 314 accepts input of a command or the like to the terminal device 300 by the user. In a tablet device, the operating unit 314 is disposed on the display unit 310 constituted by a liquid crystal panel or the like and preferably includes a touch panel to detect the touched position and an operation key unit (neither of these are illustrated). Softkeys are displayed on the display unit 310 in order to operate the terminal device 300, and hardkeys are disposed on the operation key unit. The CPU 302 monitors the user's operations on these keys. The user can input commands to the terminal device 300 by touching these keys. The selection of a softkey displayed on the display panel is performed by detecting the touched position via the touch panel.

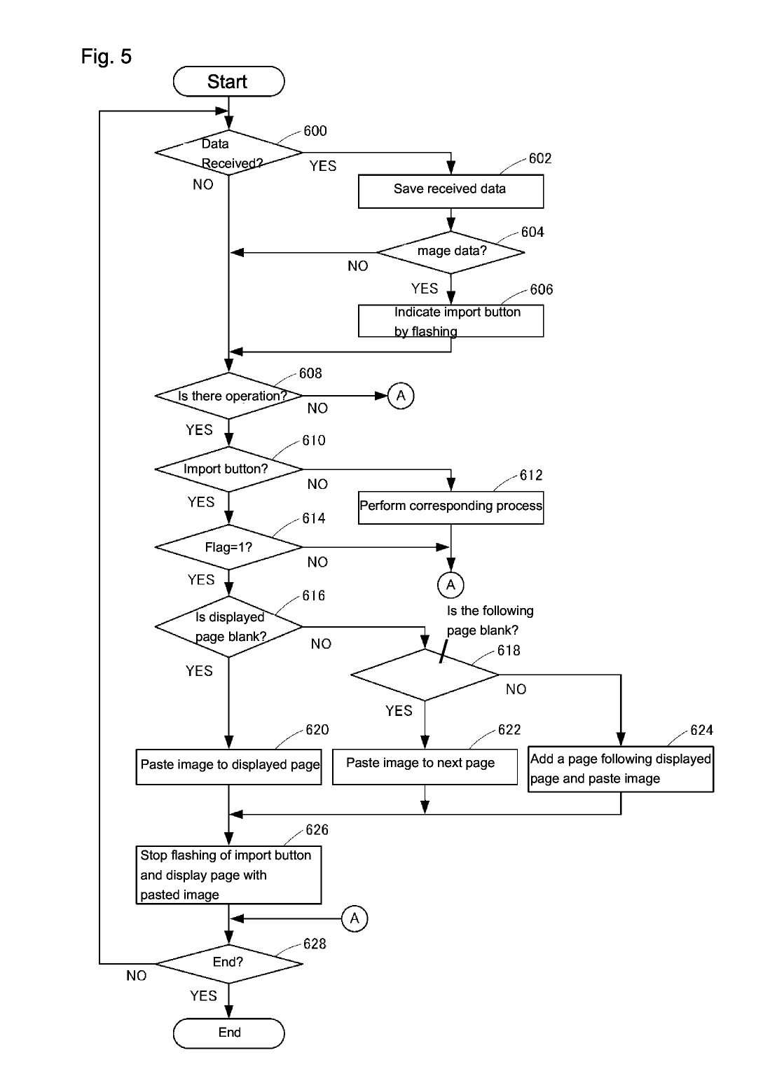

The control structure of a program that is executed in the image display device 200 in FIG. 1 and that displays image data received via the network 410 will be described below with reference to FIG. 5. In particular, it is assumed that a presenter receives image data from the terminal device 300 while giving a presentation by using the image display device 200 to sequentially display a series of page images, and a description will be given of how the received image data is processed by this program.

In the following description, it is assumed that the image display device 200 is an electronic whiteboard device installed in a location where a presentation, conference, or the like is held. This program is automatically executed when the power for the image display device 200 is switched on, thus creating a state in which normal functions such as image display and network communication become possible.

It is assumed that the image display device 200 has not received image data at a point when a presenter starts a presentation. Assume that the presenter has started the presentation, after which an email with an attachment of image data is sent to the image display device 200 as a result of the terminal device 300 being operated by a user.

In Step 600, the CPU 202 controls the communication IF unit 216 and determines whether or not data has been received via the network 410. In concrete terms, the CPU 202 determines whether or not an email has been received. If the receipt of the email is determined, the control transitions to Step 602. If not, the control transitions to Step 608.

In Step 602, the CPU 202 stores the received email in the storage unit 208. Afterward, the control transitions to Step 604.

In Step 604, the CPU 202 determines whether or not a file is attached to the received email and whether or not the attached file is an image data file (hereinafter also referred to as “image file) that the image display device 200 can display. In cases where the attached file is determined to be an image file that is displayable on the image display device 200, the control transitions to Step 606. If not, that is, if no file is attached, the attached file is not an image file, or the attached file is an image file that is not displayable on the image display device 200, then the control transitions to Step 608.

The determination of whether or not the file attached to the email is an image data file can be made, for example, based on whether or not the extension of the attached file is an extension indicating image data. The extension of an image file is BMP, JPG, JIF, JPEG, GIF, TIF, TIFF, PCT, PNG, or the like, for example. Therefore, the CPU 202 reads the extensions of image files that are stored in advance in the storage unit 208 and that are displayable on the image display device 200, compares these with the extension of the attached file, and determines whether or not it is an image file that is displayable on the image display device 200, for example.

In Step 606, the CPU 202 indicates the import button 244 displayed on the display unit 210 by flashing, for example. Furthermore, the CPU 202 sets a specified flag secured in a specified region of the RAM 206 to “1.” The initial setting of the flag is “0,” which indicates a state in which the image display device 200 has not received any displayable image file. The flag indicates whether or not image data displayable on the image display device 200 is stored in the storage unit 208. Specifically, if the flag is “1,” then image data that is displayable on the image display device 200 is stored in the storage unit 208, and if the flag is “0,” then the image data is not stored in the storage unit 208.

In order to indicate the import button 244 by flashing, all that is necessary is to store in advance two types of icon data representing the import button 244 and having the same design with different degrees of brightness, for example, and to write these two types of icon data in a specified position of the VRAM region alternately at specified time intervals.

In Step 608, the CPU 202 determines whether or not the operating unit 214 has been operated. In concrete terms, the CPU 202 uses the touch detection device to determine whether or not a softkey displayed on the display unit 210 (such as a button displayed in the function button area 240 or the page operation area 260) has been touched. If the operation has been determined, the control transitions to Step 610. If not, the control transitions to Step 628.

In Step 610, the CPU 202 determines whether or not the operation detected in Step 608 is an operation of the import button 244 (touching of the import button 244). If the operation of the import button 244 has been determined, the control transitions to Step 614. If not, the control transitions to Step 612.

In Step 612, the CPU 202 performs a process corresponding to the operation detected in Step 608. When a function button displayed in the function button area 240 (a button other than the import button 244) or a button within the page operation area 260 is touched, a corresponding process is performed as described above.

In Step 614, the CPU 202 determines whether or not the value of the flag stored in the storage unit 208 is “1.” If the value of the flag is “1,” the control transitions to Step 616. If not (if the flag is “0”), then the control transitions to Step 628.

In Step 628, the CPU 202 determines whether or not an end command is received. An example of an end command is to switch off the power of the image display device 200. When it is determined that the end command has been received, this program ends. If not, the control transitions to Step 600.

Thus, by repeating Steps 600 through 614 and Step 628, the image display device 200 receives the presenter's operations and performs corresponding processes until the image display device 200 receives a displayable image file. When an image file displayable on the image display device 200 is received, the image display device 200 flashes the import button 244, and until the import button 244 is operated, the device receives the presenter's operations and performs corresponding processes. When the import button 244 is operated by the presenter, the processes described below are performed.

In Step 616, the CPU 202 determines whether or not the page currently displayed on the display unit 210 (image displayed in the drawing area 250) is a blank page. If it is determined to be a blank page, the control transitions to Step 620. If not, the control transitions to Step 618.

The “blank page” indicates a page that does not contain any object (a page containing some type of object is called a “non-blank page”). Therefore, the CPU 202 determines whether or not information specifying the object (such as the name of the object) is stored in the storage unit 208 with correspondence being made to the information specifying the currently displayed page (such as the page number).

For instance, when a presentation is started, the CPU 202 secures in page units regions in the RAM 206 where image data of a specified number of pages (such as five pages, for example) can be stored. Each region secured in a page unit is called a “virtual page.” Specifically, each virtual page includes data that is displayed simultaneously as one page in the drawing area 250. Data within a single virtual page is, for example, data directly representing individual pixels such as bitmap data of an image. A virtual page can contain information specifying an object such as a drawn figure. A figure drawn by the presenter by operating a touch pen is stored as an object on a virtual page.

Each virtual page that has just been secured corresponds to a blank page (a page containing no object). For instance, a virtual page is first secured as a data region with the number of pixels corresponding to that of the drawing area 250, where the value of all of the pixels is the same specified value (if full color display is possible, for example, every single bit of 24-bit data is “0” or “1”). Data stored on a virtual page is written as image data in the VRAM region as needed and displayed on the display unit 210.

In the case of using data stored in the storage unit 208 (such as an image file), the CPU 202 reads data specified by the presenter from the storage unit 208 and writes it on five pages worth virtual pages stored in the RAM 206. If the data read from the storage unit 208 is larger than a space corresponding to five pages, virtual pages with the number of pages enough to write all of the specified data are secured. At a stage at which the image data has been written on the virtual pages, the corresponding pages are pages containing objects, i.e., non-blank pages.

The specified number of virtual pages stored in the RAM 206 do not necessarily need to be secured as physically continuous regions. When virtual pages are not secured as continuous regions, it is sufficient if information specifying the order of display of the various virtual pages on the display unit 210 when the page forward button 262 is operated is stored in a specified region of the RAM 206. The CPU 202 can decide the virtual pages to be displayed upon receipt of the presenter's operation by referring to the information specifying this order.

Note that processes performed on pages will be described below, but such a description refers, in concrete terms, to processes performed on data stored on virtual pages secured in the RAM 206. For example, a statement “an image is pasted to a page” indicates that image data is written to a corresponding virtual page in the RAM 206.

In Step 618, the CPU 202 determines whether or not the page following the displayed page is a blank page. If the next page is determined to be a blank page, then the control transitions to Step 622. If not, the control transitions to Step 624.

In Step 620, the CPU 202 pastes the received image data to the displayed page. In concrete terms, the CPU 202 reads the received image data from the storage unit 208 and writes it on a virtual page in the RAM 206 corresponding to the page on display. Afterward, the control transitions to Step 626.

In Step 622, the CPU 202 pastes the received image data to the page following the displayed page. In concrete terms, the CPU 202 reads the received image data from the storage unit 208 and writes it on a virtual page in the RAM 206 corresponding to the page following the page on display. Afterward, the control transitions to Step 626.

In Step 624, the CPU 202 adds a new page following the displayed page and pastes the received image data to this page. In concrete terms, after a virtual page for storing data of the page to be displayed following the page on display is newly secured in the RAM 206, the CPU 202 reads the received image data from the storage unit 208 and writes it on the newly secured virtual page. Afterward, the control transitions to Step 626.

Note that when a new virtual page is secured in the RAM 206, it is not necessary to secure it between virtual pages corresponding to the page on display and the next page as physically continuous regions. When virtual pages are not secured as physically continuous regions, it is sufficient if information specifying the order in which data of the various virtual pages secured in the RAM 260 is displayed as images is stored in a specified region of the RAM 206 as described above.

In Step 626, the CPU 202 stops flashing indication of the import button 244 and displays the page with the pasted image on the display unit 210. At this point, the display in the page number display field 266 is changed to the page number corresponding to the page that has been displayed. In concrete terms, the CPU 202 cancels the flashing process started in Step 606 and writes in a VRAM region the data of the virtual page to which the received image data has been written as a result of at least one of Steps 620 through 624 being performed. Afterward, the control transitions to Step 628, and the aforementioned processes are performed.

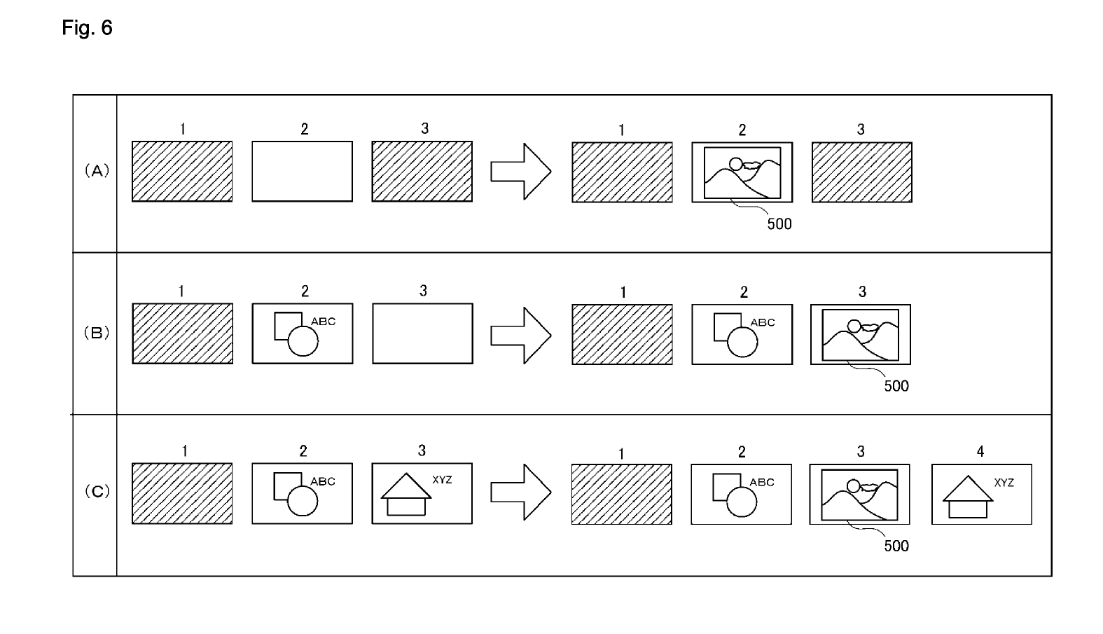

The processes of Steps 616 through 626 will be described in further detail with reference to FIG. 6. In the description above, it was assumed that five pages worth of virtual pages, for example, are secured in the RAM 206 upon the start of the presentation. Here, however, to simplify the description, it is assumed that three pages worth virtual pages are secured, for example. In FIG. 6, virtual pages secured in the RAM 206 (a total of three pages worth of regions) are shown in model form with rectangles on both sides of rightward arrows (hereinafter referred to simply as “arrows”). Image data to be displayed as a page on the display unit 210 is shown in each of the rectangular regions (virtual pages). A state immediately before performing the processes of Steps 616 through 626 is shown on the left side of each of the arrows. A state immediately after performing the processes of Steps 616 through 626 is shown on the right side of each arrow. A white virtual page indicates a blank page, while a hatched virtual page indicates any page (i.e., a blank page or non-blank page). A virtual page containing a figure or the like indicates a non-blank page. The number on top of each virtual page (hereinafter referred to as a “page number”) indicates the order in which the respective virtual pages are displayed on the display unit 210 when the page forward button 262 is operated.

Here, it is assumed that the virtual page assigned with the page number “2” on the left side of each arrow corresponds to the page displayed on the display unit 210. That is, it is assumed that Steps 616 through 626 are performed in a state in which the data of the virtual page assigned with the page number “2” is written to the VRAM region.

In the state shown on the left side of the arrow in FIG. 6(A), the page on display (virtual page of page number “2”) is a blank page, so when Step 616 is performed, the control transitions to Step 620. As a result of Step 620 being performed, a state is created in which received image data 500 is written to the virtual page that is on display as shown on the right side of the arrow. When Step 626 is performed thereafter, the virtual page assigned with the page number “2” is displayed on the display unit 210.

In the state shown on the left side of the arrow in FIG. 6(B), the virtual page on display (page number “2”) is not a blank page, so when Step 616 is performed, the control transitions to Step 618. Because the next virtual page (page number “3”) is a blank page, when Step 618 is performed, the control transitions to Step 622. As a result of Step 622 being performed, a state is created in which received image data 500 is overwritten to the next virtual page (page number “3”) as shown on the right side of the arrow. When Step 626 is performed thereafter, the virtual page assigned with the page number “3” is displayed on the display unit 210.

In the state shown on the left side of the arrow in FIG. 6(C), the virtual page on display (page number “2”) is not a blank page, so when Step 616 is performed, the control transitions to Step 618. Because the next virtual page (page number “3”) is not a blank page, either, when Step 618 is performed, the control transitions to Step 624. As a result of Step 624 being performed, a state is created in which a new virtual page (page number “3”) is secured between the virtual page on display (page number “2”) and the next virtual page (page number “4”), and received image data 500 is overwritten to this virtual page as shown on the right side of the arrow. Note that because a virtual page is newly secured, the page number of the virtual page whose page number on the left side of the arrow was “3” is changed to “4” on the right side of the arrow. Afterward, when Step 626 is performed, the page assigned with the page number “3” on the right side of the arrow is displayed on the display unit 210.

Thus, when the image display device 200 receives image data from an external device such as the terminal device 300 while a presenter is giving a presentation, the only thing that happens is that the import button 244 is indicated by flashing, so the effect on the presentation can be significantly reduced or prevented. Then, because the receipt of image data that is displayable on the image display device 200 can be understood by the flashing of the import button 244, the presenter can display the received image data on the display unit 210 by touching the import button 244 as needed at a desired timing. When the received image is to be displayed, it is displayed without being superimposed on the page that is on display, so there is no effect on the image data used in the presentation. Moreover, if the page on display is a blank page, the received image data is stored on this page on display, and if the page on display is not a blank page, the received image data is stored on the next page, so the received image data can be added at any time during the course of the presentation.

For example, when the presenter knows in advance that information (image data) necessary for the presentation will be sent, the presenter can see that the necessary information has been received as a result of the flashing of the import button 244. Therefore, the presenter can display the received image data on the display unit 210 by touching the import button 244 at a desired time determined by the presenter or attendee, for example, without interfering with or affecting the progress or status of the presentation. On the other hand, when transmission of information (image data) related to the presentation is not expected, the presenter can ignore the flashing of the import button 244 because the received image data is irrelevant to the presentation and can carry on the presentation to the end without touching the import button 244.

When received image data is to be displayed on the display unit 210, various methods are conceivable as to how to handle the received image data in the RAM 206 by taking into consideration data of a series of images used in a presentation or the like. Specifically, the flowchart shown in FIG. 5 can be implemented with various modifications as shown below.

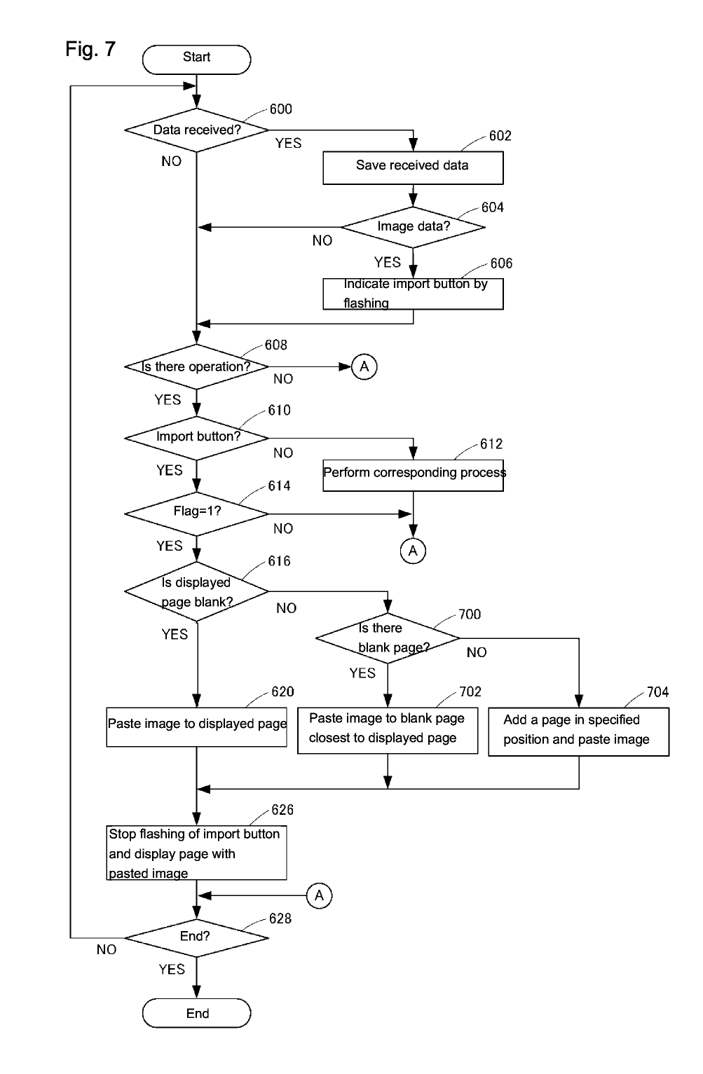

In the description above, whether or not the page following the page on display is a blank page is determined in Step 618 of FIG. 5, but the process is not limited to this. For example, it is also possible to determine whether or not there is a blank page in the data of a series of images as shown in FIG. 7. In the flowchart of FIG. 7, processes in steps assigned with the same reference numbers as those of the flowchart of FIG. 5 are the same as those of FIG. 5, so a redundant description will not be given. The only difference in FIG. 7 from FIG. 5 is that Step 618, Step 622, and Step 624 are replaced by Steps 700 through 704.

If the page on display is determined not to be a blank page in Step 616, then the CPU 202 determines in Step 700 whether or not there is a blank page in the data of the series of images to be currently displayed. In concrete terms, the CPU 202 determines whether or not there is a blank page in the series of virtual pages secured in the RAM 206. If it is determined that there is a blank page, the control transitions to Step 702. If not, the control transitions to Step 704.

In Step 702, the CPU 202 pastes the received image data to a blank page closest to the currently displayed page. In concrete terms, the CPU 202 reads the received image data from the storage unit 208 and overwrites it on a blank virtual page in the RAM 206 closest to the currently displayed page in the order of display. Afterward, the control transitions to Step 626.

In Step 704, the CPU 202 newly adds a page in a specified position in the RAM 206 and pastes the received image data to this new page. In concrete terms, after securing a new virtual page other than the series of virtual pages secured in the RAM 206, the CPU 202 reads the received image data from the storage unit 208 and overwrites it on the newly secured virtual page. Afterward, the control transitions to Step 626. Note that it is only necessary for the position in which a new virtual page is added to be set in advance as needed. For example, a new virtual page may be added immediately following the page on display as in Step 624 of FIG. 5. Furthermore, it is also possible to add a new virtual page immediately before the page on display or to add a new virtual page at the end of the series of virtual pages.

By doing this as well, when the received image is to be displayed, it is displayed without being superimposed on the page on display, so there is no effect on the image data used in the presentation.

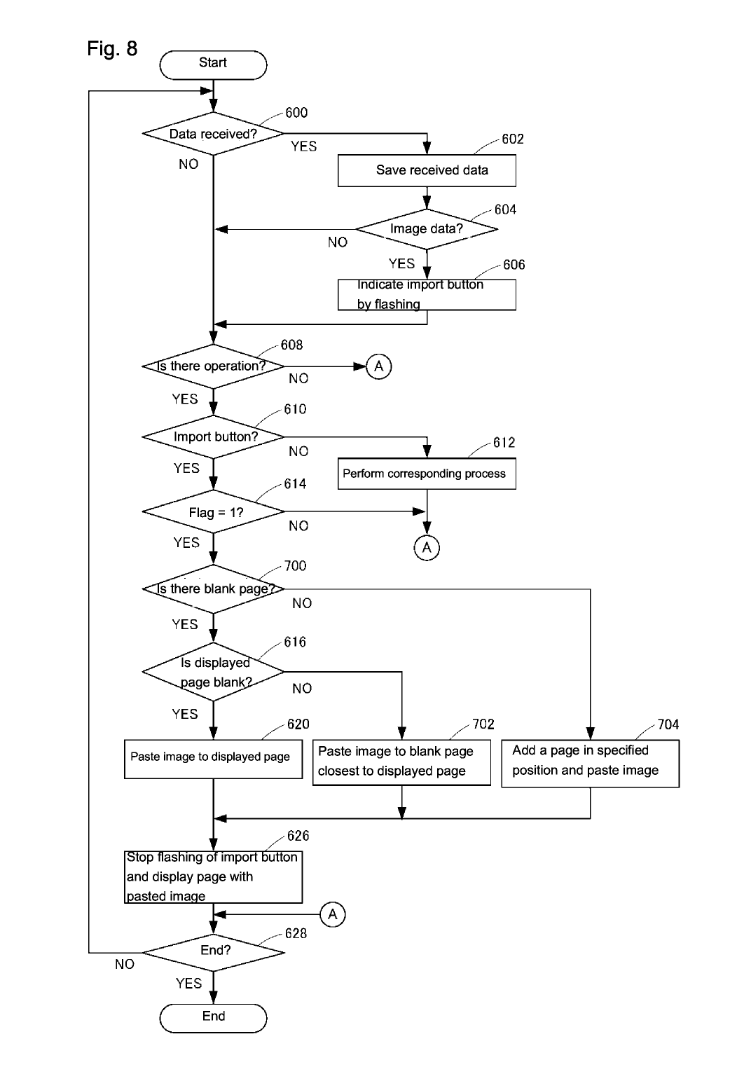

Moreover, FIG. 7 may be modified as shown in FIG. 8. In the flowchart of FIG. 8, processes in steps assigned with the same reference numbers as those of the flowchart of FIG. 7 are the same as those of FIG. 7, so a redundant description will not be given. The only difference in FIG. 8 from FIG. 7 is the order in which Step 616 and Step 700 are performed. Specifically, in the program shown in FIG. 8, when it is determined in Step 700 that there is a blank page in the data of the series of images to be displayed, the control transitions to Step 616. If it is determined in Step 700 that there is no blank page in the data of the series of images to be displayed, then the control transitions to Step 704. If it is determined in Step 616 that the page on display is a blank page, the control transitions to Step 620. If not, the control transitions to Step 702.

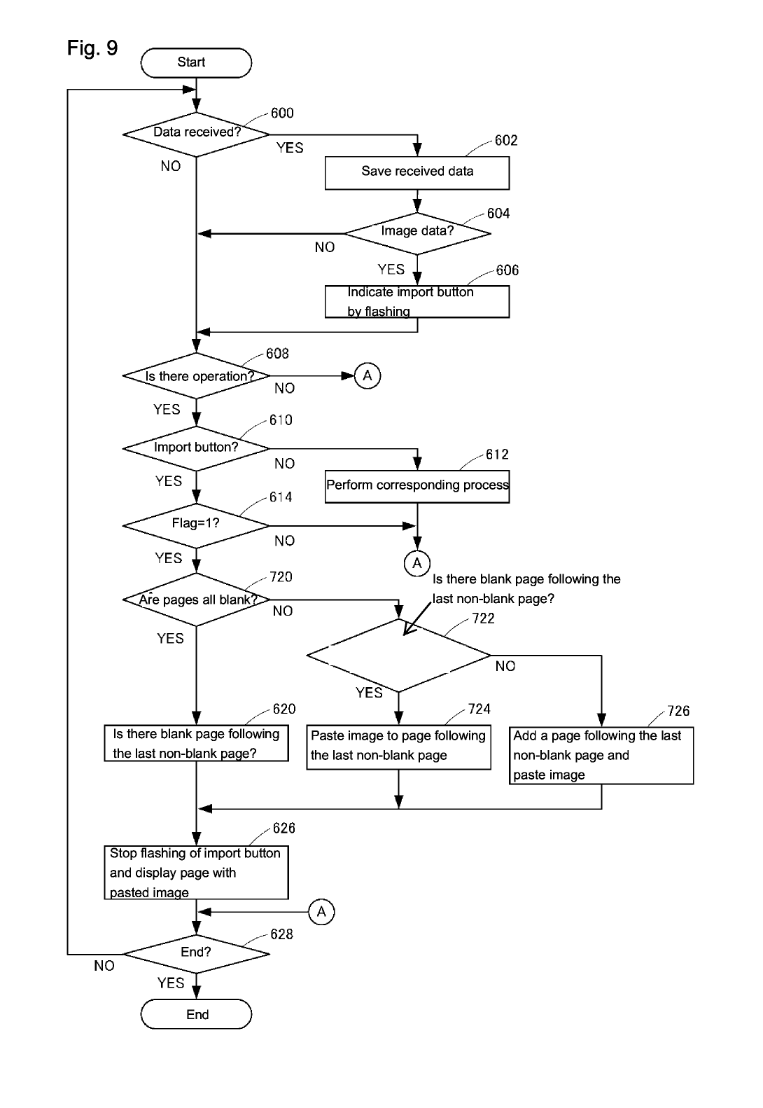

In addition, it is also possible to decide the position where the received image data is pasted as shown in FIG. 9. In the flowchart of FIG. 9, processes in steps assigned with the same reference numbers as those of the flowchart of FIG. 5 are the same as those of FIG. 5, so a redundant description will not be given. The only difference in FIG. 9 from FIG. 5 is that Step 616, Step 618, Step 622, and Step 624 are replaced by Steps 720 through 726.

If the flag is determined to be “1” in Step 614, then the CPU 202 determines in Step 720 whether or not the series of pages to be displayed are all blank pages. If all of the pages are determined to be blank pages, the control transitions to Step 620, and the received image data is pasted to the page on display (the received image data is written to the corresponding virtual page in the RAM 206). If not, the control transitions to Step 722.

In Step 722, the CPU 202 determines whether or not there is a blank page following the non-blank page that is the last in the display order among the non-blank pages. If it is determined that there is a blank page, the control transitions to Step 724. If not, the control transitions to Step 726.

In Step 724, the CPU 202 pastes the received image data to the page (blank page) following the last non-blank page.

In Step 726, the CPU 202 newly adds a page following the last non-blank page and pastes the received image data. In concrete terms, a virtual page is newly secured in the corresponding position in the RAM 206, and the received image data is written thereto. Afterward, the control transitions to Step 626.

With this as well, when the received image is to be displayed, it is displayed without being superimposed on the page on display, so there is no effect on the image data used in the presentation.

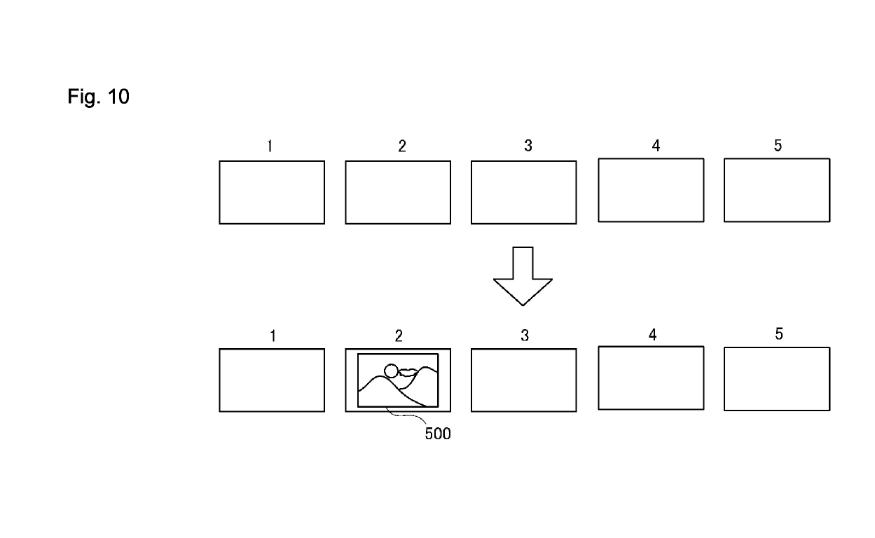

The processes of Steps 720 through 726 and Step 620 in FIG. 9 will be described in further detail with reference to FIGS. 10 through 12. Virtual pages (for example, a total of five pages worth of regions) secured in the RAM 206 are shown in model form above and below the downward arrow (hereinafter referred to simply as “arrow”) in each of FIGS. 10 through 12. Each of the virtual pages represents image data displayed as one page. A state immediately before performing the processes of Step 620, Step 724, or Step 726 is displayed on the upper side of each arrow. A state immediately after performing the processes of Step 620, Step 724, or Step 726 is displayed on the lower side of each arrow. The meanings of the white virtual pages, hatched virtual pages, and virtual pages containing a figure or the like are the same as in FIG. 6. The meaning of the number above each virtual page is also the same as in FIG. 6. Here, as in FIG. 6, it is assumed that the virtual page assigned with the page number “2” on the upper side of each arrow corresponds to the page displayed on the display unit 210.

In the state shown on the upper side of the arrow in FIG. 10, the five pages to be displayed are all blank pages, so when Step 720 is performed, the control transitions to Step 620. As a result of Step 620 being performed, a state is created in which received image data 500 is written to the virtual page on display (page number “2”) as shown on the lower side of the arrow. When Step 626 is performed thereafter, the page corresponding to the virtual page assigned with the page number “2” is displayed on the display unit 210.

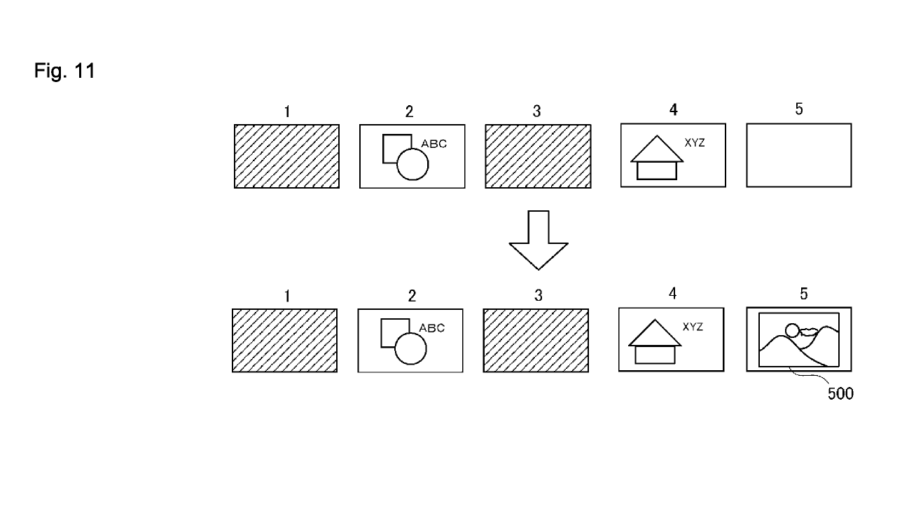

In the state shown on the upper side of the arrow in FIG. 11, non-blank pages (page numbers “2” and “4”) are included in the five pages to be displayed, so when Step 720 is performed, the control transitions to Step 722. The virtual page (page number “5”) following the virtual page corresponding to the last non-blank page (page number “4”) is a blank page, so when Step 722 is performed, the control transitions to Step 724. As a result of Step 724 being performed, a state is created in which received image data 500 is written to the virtual page (page number “5”) following the last non-blank page as shown on the lower side of the arrow. When Step 626 is performed thereafter, the page corresponding to the virtual page assigned with the page number “5” is displayed on the display unit 210.

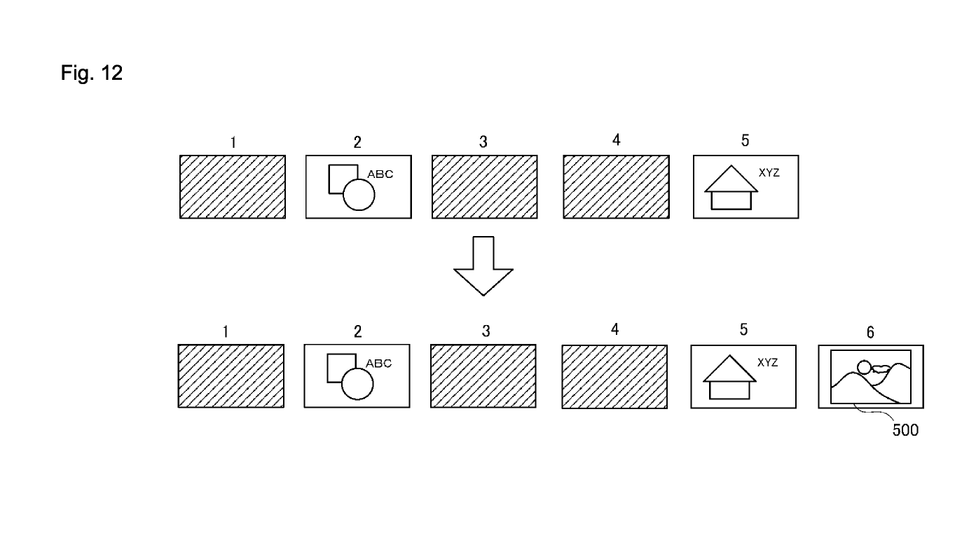

In the state shown on the upper side of the arrow in FIG. 12, non-blank pages (page numbers “2” and “5”) are included in the five pages to be displayed, so when Step 720 is performed, the control transitions to Step 722. There is no blank page following the virtual page corresponding to the last non-blank page (page number “5”), so when Step 722 is performed, the control transitions to Step 726. As a result of Step 726 being performed, a state is created in which a virtual page (page number “6”) is newly added following the virtual page corresponding to the last non-blank page, and received image data 500 is written to the added virtual page as shown on the lower side of the arrow. When Step 626 is performed thereafter, the page assigned with the page number “6” is displayed on the display unit 210.

Thus, by adding a virtual page behind all of the data used in a conference, presentation, or the like and storing the received data thereon, it becomes easier to confirm only the received data after the presentation. In cases where data of a plurality of images is received, in particular, it is possible to store all together at the end, so confirming the received data becomes even easier. In addition, if there is a blank page behind all of the data used in a conference, presentation, or the like, the received data is stored on this blank page without adding any virtual page (FIG. 11), so the memory can be used efficiently.

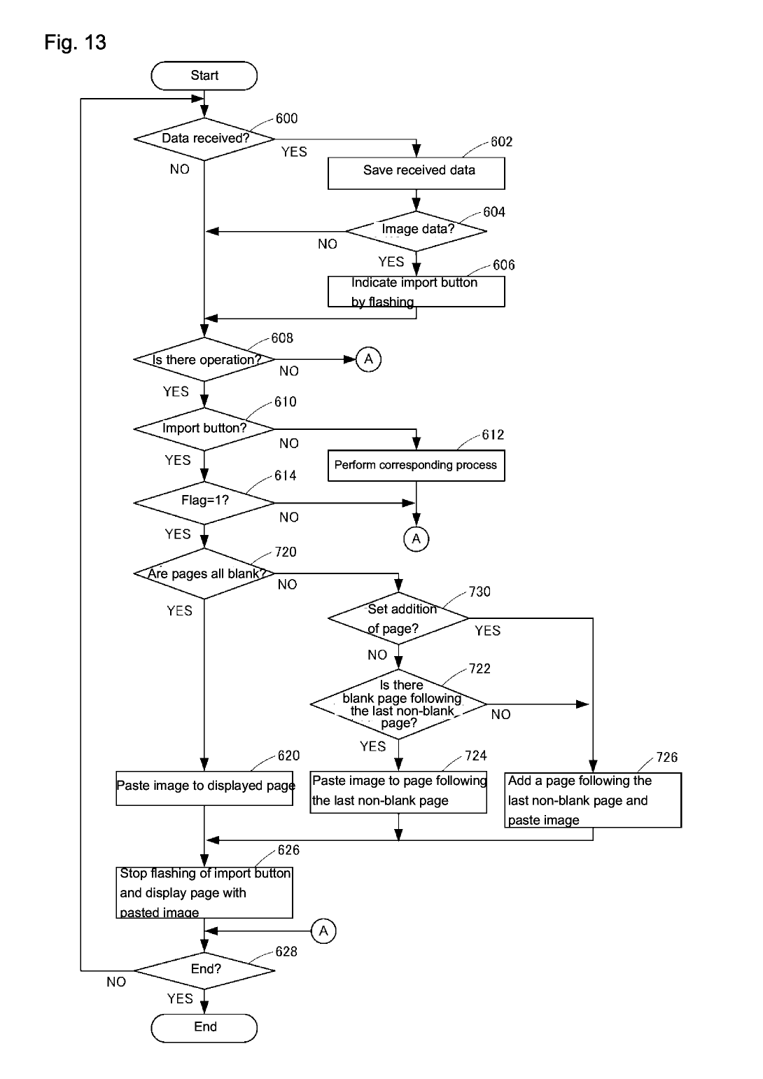

Furthermore, FIG. 9 may be modified as shown in FIG. 13. In the flowchart of FIG. 13, processes in steps assigned with the same reference numbers as those of the flowchart of FIG. 9 are the same as those of FIG. 9, so a redundant description will not be given. The only difference in FIG. 13 from FIG. 9 is that in FIG. 13, Step 730 is added in front of Step 722.

In the program shown in FIG. 13, if there is a non-blank page in the series of pages to be displayed, the process of adding a new page is prioritized.

When it is determined in Step 720 that there is a non-blank page in the series of pages to be displayed, the CPU 202 determines in Step 730 whether or not the setting is such that the addition of a new virtual page is prioritized. The setting of whether or not to prioritize the addition of a new virtual page is established beforehand, and for instance, as the initial setting at the time of the startup of the image display device 200, a specified flag (hereinafter referred to as “priority flag”) is read out from the storage unit 208 and stored in a specified region in the RAM 206. Based on the value of the priority flag stored in a specified region in the RAM 206, the CPU 202 determines whether or not the setting is such that the addition of a new virtual page is prioritized. For example, if the priority flag is “1,” it is determined to have the setting such that the addition of a new virtual page is prioritized, and if the priority flag is “0,” then it is determined not to have the setting such that the addition of a new virtual page is prioritized. If it is determined to have the setting such that the addition of a new virtual page is prioritized, the control transitions to Step 726. If not, the control transitions to Step 722.

Accordingly, if the setting is such that the addition of a new virtual page is prioritized (the priority flag is “1”), then Step 726 is performed without making a determination as to whether or not there is a blank page following the last non-blank page. Only when there is no setting so as to prioritize the addition of a new virtual page (the priority flag is “0”), determination is made in Step 722 as to whether or not there is a blank page following the last non-blank page, and depending on the result thereof, either Step 724 or Step 726 is performed.

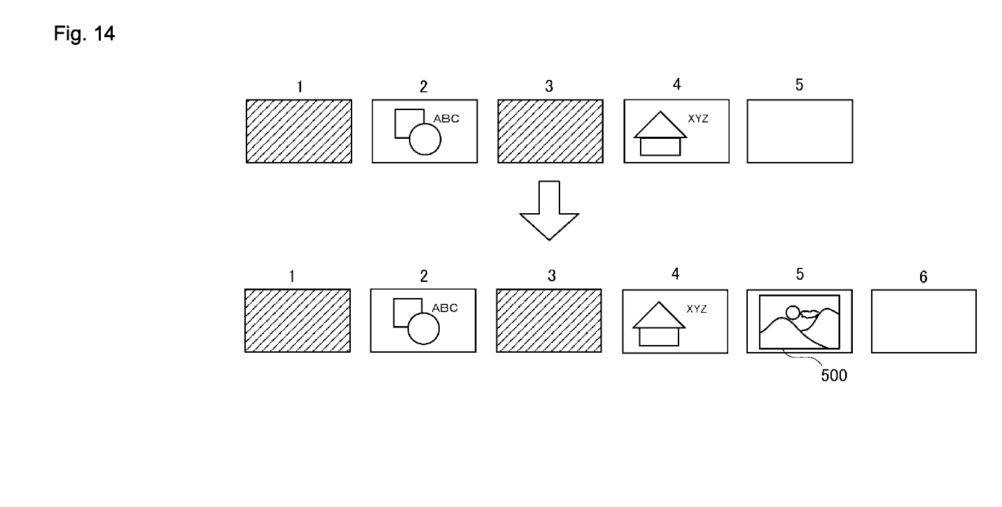

The process of Step 730 will be described in further detail with reference to FIG. 14. FIG. 14 is a diagram similar to FIGS. 10 through 12. The meanings of the plurality of virtual pages disposed above and below the downward arrow (hereinafter referred to simply as “arrow”) and the number above each virtual page are the same as in FIGS. 10 through 12. Here, it is assumed that the virtual page assigned with the page number “2” on the upper side of each arrow corresponds to the page displayed on the display unit 210.

In the state shown on the upper side of the arrow in FIG. 14, the pages are the same as in the state shown on the upper side of the arrow in FIG. 11. However, the result of executing the program in FIG. 14 (the state shown on the lower side of the arrow in FIG. 14) depends on whether or not a setting has been established so as to prioritize the addition of a new virtual page (whether or not the priority flag is “1”). In the state shown on the upper side of the arrow in FIG. 14, non-blank pages (page numbers “2” and “4”) are included in the five pages to be displayed, so when Step 720 is performed, the control transitions to Step 730. If the setting is such that the addition of a new virtual page is prioritized (the priority flag is “1”), then as a result of Step 730 being performed, the control transitions to Step 726. Therefore, a new virtual page (page number “5”) is added following the virtual page corresponding to the last non-blank page (page number “4”) as shown on the lower side of the arrow, and a state is created in which the received image data 500 is written to the added virtual page. When Step 626 is performed thereafter, the page assigned with the page number “5” is displayed on the display unit 210.

On the other hand, if the setting is not such that the addition of a new virtual page is prioritized (the priority flag is “0”), then Step 722 is performed. Because the virtual page (page number “5”) following the virtual page corresponding to the last non-blank page (page number “4”) is a blank page, when Step 722 is performed, the control transitions to Step 724. As a result of Step 724 being performed, a state is created in which the received image data 500 is written to the virtual page following the last non-blank page as shown on the lower side of the arrow in FIG. 11.

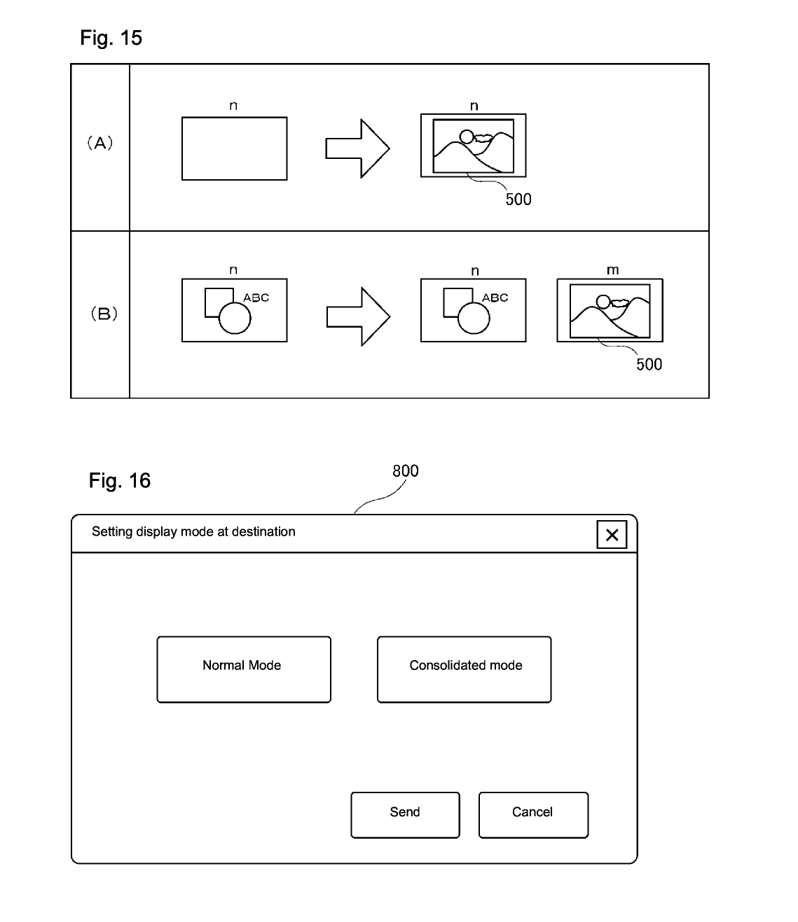

For the method for deciding the position where the received image data is to be pasted, various methods are conceivable in addition to the methods described above. In any method, if there is a non-blank page in the series of virtual pages to be displayed, then all that is necessary is to write the received image data 500 to a region other than the detected non-blank page as shown in FIG. 15. Specifically, if there is a blank page, the received image data 500 is written to the existing virtual page (page number “n”) corresponding to the blank page (see FIG. 15(A)), or a virtual page (page number “m,” where m n) is newly added regardless of whether or not there is a blank page, and the received image data is written to the new page (see FIG. 15(B)). Note that in FIG. 15, there may be virtual pages besides the displayed virtual pages of the page numbers “n” and “m.”

In the description above, a case was described in which the image file received by the image display device 200 preferably contains data of a single image, but the present invention is not limited to this. Even in cases where the image display device 200 receives a plurality of (N) image files each of which contains data of a single image, or in cases where data of a plurality of (N) images is contained in a single image file received by the image display device 200, the received image data can be stored on virtual pages in the RAM 206 in the same manner as described above. That is, it is sufficient if virtual pages corresponding to N blank pages are detected in the RAM 206 and the received image data is stored thereon. If it is not possible to detect virtual pages corresponding to N blank pages in the RAM 206, all that is necessary is to newly secure the required number of virtual pages and to store the received image data thereon. In concrete terms, when data of N images is received, the aforementioned series of processes (FIG. 5, etc.) may be repeatedly performed for data of each image. A received image is displayed on the display unit 210 every time the series of processes is performed. When the received data of all of the images is processed, a state is produced in which the data of the image processed at the end is displayed on the display unit 210 as an image.

In cases where the image display device 200 receives data of numerous images at once as described above, images are sequentially displayed one page at a time when the import button 244 is pressed, so this is time-consuming and cumbersome. It is preferable if a plurality of images can be displayed in a consolidated manner on one page. For example, when the user sends image data from the terminal device 300 to the image display device 200, it is preferable if the image data can be sent with the display mode being specified, and the image display device 200 can display the received image data in accordance with the received display mode.

In concrete terms, in the terminal device 300, the CPU 302 executes an application program to send an email upon receipt of user's command and accepts the identification of an image file to be attached. When a send command is received thereafter, the CPU 302 displays on the display unit 310 a screen such as the screen 800 shown in FIG. 16. The screen 800 is a screen that specifies the mode in which the image data to be sent is displayed at the destination (image display device 200). A “normal mode” button, a “consolidated mode” button, a “send” button, and a “cancel” button are displayed on the screen 800. The normal mode button is a button to instruct the mode to displaying data of a single image in one page, while the consolidated mode button is a button to specify the mode to display data of a plurality of images in one page. The send button is a button to instruct the transmission of an email. The cancel button is a button to instruct the cancellation of the email transmission.

When the display unit 310 and the operating unit 314 constitute a touch panel display in the terminal device 300, the user can touch the normal mode button or consolidated mode button to select either one (the CPU 302 can detect which mode is selected). The selected button is displayed, for example, with the brightness being reversed such that the selected state can be seen. When the user touches the send button in a state in which the normal mode is selected, the CPU 302 sends to the image display device 200 an email with an attachment of specified image data. On the other hand, when the user touches the send button in a state in which the consolidated mode is selected, the CPU 302 displays a screen to set a consolidation condition (the number of images to be displayed in one page, the layout of the images within one page, etc.). After the consolidation condition is set by the user, the CPU 302 sends to the image display device 200 an email with an attachment of specified image data and the consolidation condition.

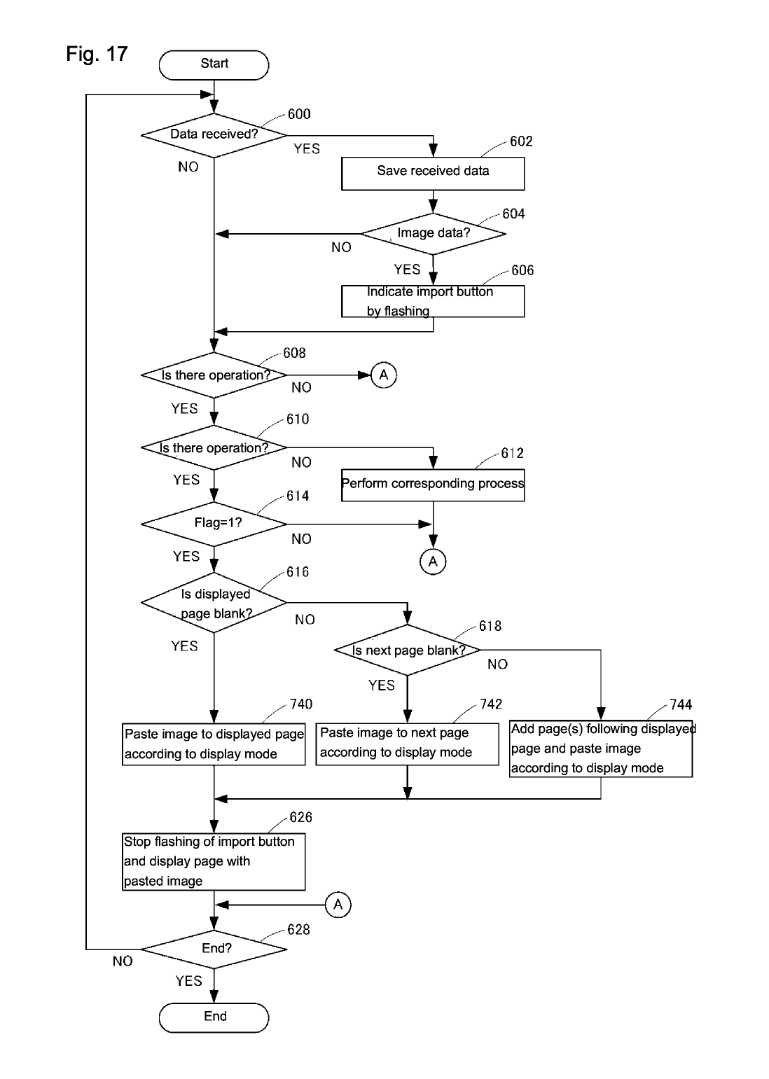

The image display device 200 executes the program shown in FIG. 17, for example. In the flowchart of FIG. 17, processes in steps assigned with the same reference numbers as those of the flowchart of FIG. 5 are the same as those of FIG. 5, so a redundant description will not be given. The only difference in FIG. 17 from FIG. 5 is that Steps 620 through 624 in FIG. 5 are replaced by Steps 740 through 744.

Specifically, if the data received in Step 600 includes no consolidation condition, in Step 740, the CPU 202 pastes the received image to the displayed page (blank page) (the received image data is stored on the corresponding virtual page in the RAM 206). At this point, if data of a plurality of images is received, necessary virtual pages are created in the RAM 206, for example, and the data of the remaining images is stored. On the other hand, if the received data contains the consolidation condition, the CPU 202 pastes the received plurality of images to the displayed page(s) according to the received consolidation condition. In cases where all of the received images cannot be pasted on the displayed page(s), necessary virtual pages are added, and the data of the remaining images is stored similarly in a consolidated manner.

The process of Step 742 differs from that of Step 740 only in that the image data is pasted to the page following the page on display instead of being pasted to the page on display, and the content of the process is the same as in Step 740.

If the received data contains no consolidation condition, in Step 744, the CPU 202 newly adds the number of pages equal to the number of the received images (creates virtual pages in the RAM 206) following the page on display and pastes the received images thereto. If the consolidation condition is contained in the received data, the CPU 202 newly adds one or more pages following the page on display and pastes the plurality of received images thereto in accordance with the received consolidation condition. At this point, the number of pages to be added is preferably determined by the consolidation condition. The CPU 202 preferably adds the number of pages that allow all of the received images to be pasted in accordance with the consolidation condition.

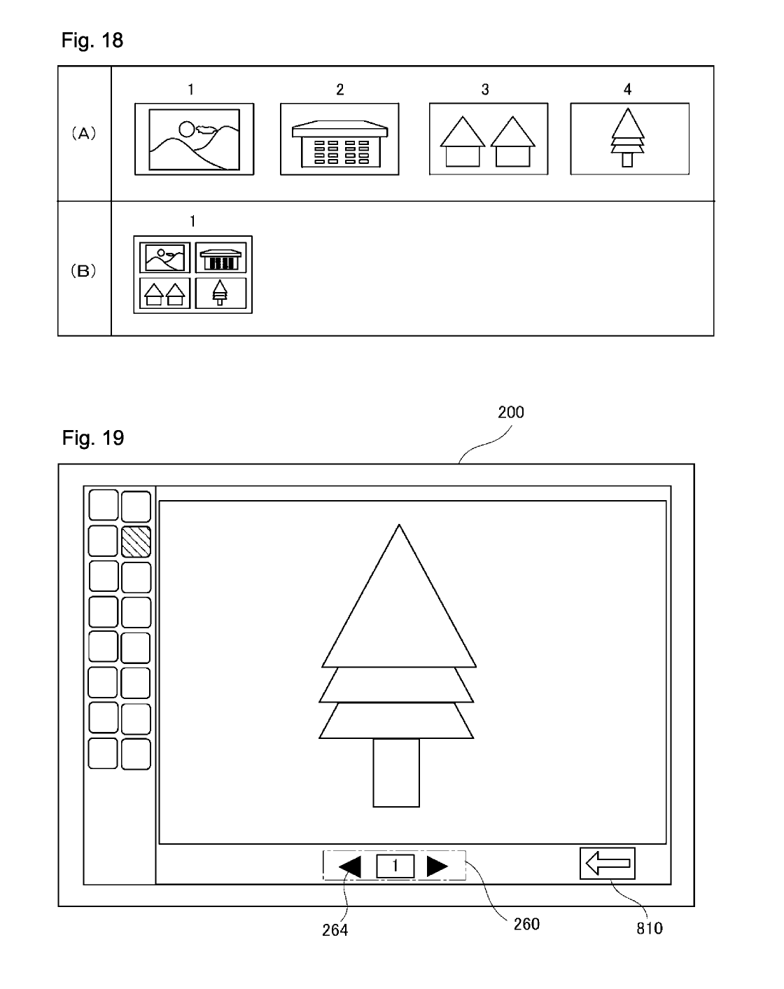

When Step 626 is performed after Step 740, Step 742, or Step 744 is performed in this manner, the received images are displayed as shown in FIG. 18, for example. FIG. 18 shows only four images to be displayed based on the image data received by the image display device 200. If no consolidation condition is included, the images are displayed over four pages as shown in FIG. 18(A). On the other hand, if the consolidation condition is included, and the consolidation condition is “four in one” (condition in which four images are consolidated and displayed in one page), then these images are all displayed together on one page as shown in FIG. 18(B).

By the foregoing method, if the number of images to be sent is large, and also the sender considers that there is no problem with reduced display, then the images are consolidated and displayed on the image display device 200, so there is no need for cumbersome operations such as returning pages, and thus efficiency is greatly improved.

Note that the image display device 200 may still display the received image data in accordance with a specified consolidation condition even when no consolidation condition is received.

Furthermore, the mode for consolidating and displaying a plurality of received images on the image display device 200 is not limited to the consolidation of “four in one,” and consolidations other than that may also be possible. Moreover, display modes other than consolidation may also be possible. It is sufficient as long as conditions specifying the display mode of the received images on the image display device 200 are sent from a terminal device to the image display device 200 together with the image data.

In the description above, when the received data of all of the images is processed, a state is created in which the data of the image processed at the end is displayed as an image on the display unit 210. However, it is also possible to display on the display unit 210 the data of the image processed at the end as an image and then to display the data of the image processed at the beginning as an image. In order to do so, all that is necessary is for the CPU 202 to store the received data of the number N of images (e.g., the number N of files) in the RAM 206. At a stage at which the data of all of the images is processed, the CPU 202 displays the image corresponding to the value of the page number obtained by subtracting the number smaller by one than the data of the number N of images, i.e., N−1, from the page number displayed at that time (value of the page field 266). Consequently, the image received at the beginning is displayed. For example, in FIG. 18(A), once the data of all four images is processed, a state is temporarily created in which the image at the right end is displayed, and immediately after that, the image at the left end is displayed.

Note that another possibility is that when the data of the image received at the beginning is processed, the CPU 202 stores the corresponding page number in the RAM 206, and at a stage at which the data of all of the images has been processed, the image corresponding to the page number stored in the RAM 206 (the data of the first image) is displayed. If this is done, it is not necessary to operate the page return button 264 when the user wants to view the images from the beginning.

Alternatively, it is also possible to display a button for returning pages when the received data of all of the images is processed (in a state in which the data of the image processed at the end is displayed as an image on the display unit 210). For example, as is shown in FIG. 18(A), images are displayed in order from the image at the left end, and when the image at the right end is displayed at the end, the CPU 202 displays an arrow button 810 for returning pages on the screen separately from the buttons in the page operation area 260 as shown in FIG. 19. Note that in order to allow the data of the first image to be specified out of the received image data, the CPU 202 stores in the RAM 206 the number of images in the received data or, when the data of the first image received is processed, the corresponding page number in the same manner as described above. When the arrow button 810 is touched, the CPU 202 can display the first of the received images in the same manner as described above. By doing so, when the user wants to view the images from the beginning, all that is necessary is to touch the arrow button 810, and there is no need for cumbersome operation of touching the page return button 264 many times.

Furthermore, the present invention is not limited to files in an image data format, and even when the image display device 200 receives a file (for example, an extension of ppt, pptx, doc, docx, pdf, etc.) that is created by an application (MS-PowerPoint, MS-Word, Acrobat, etc.) and that can be displayed in page units, such a file can be processed in a similar manner. In this case, it is sufficient if the image display device 200 produces image data (image data displayed in the drawing area 250) in page units based on the data of the received file and writes it on virtual pages in the RAM 206. The subsequent processes are for handling image data in the RAM 206, so processes are possible in the same manner as described above.

In the description above, a case was described in which preferably the import button 244 displayed on the display unit 210 flashes when the image display device 200 receives image data, but the present invention is not limited to this. It is sufficient if the image display device 200 can indicate the receipt of the image data on the display unit 210. For instance, the color of the import button 244 may be changed, or the design of the import button 244 may be changed. Alternatively, it is also possible to use flash indication of an icon displayed on the display unit 210 separate from the import button 244 or to newly display an icon (which may or may not flash) that was not displayed on the display unit 210.

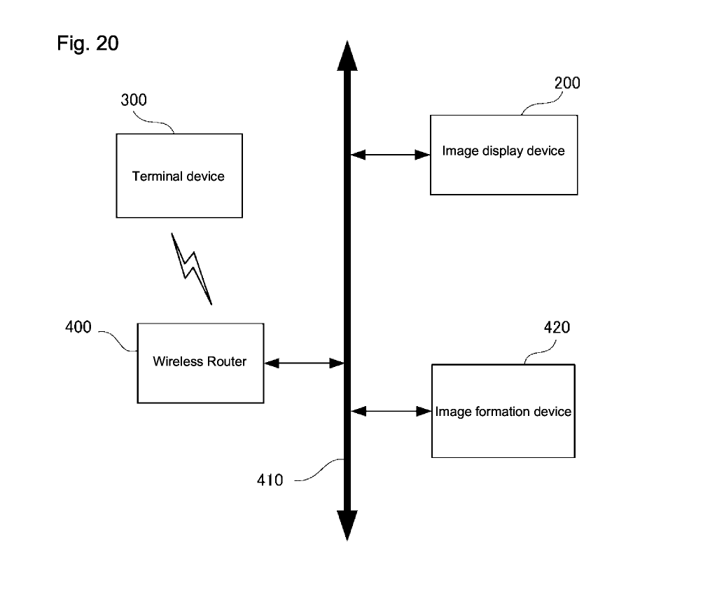

In the description above, a case was described in which image data is preferably sent from the terminal device 300 to the image display device 200, but the present invention is not limited to this. For example, an image formation device 420 may also be connected to the network 410 as shown in FIG. 20. For instance, in cases where the image formation device 420 is provided with a scanner and has the function of sending image data produced as a result of scanning the copy by attaching it to an email, or in cases where the image display device 200 receives image data sent from the image formation device 420, processes similar to the ones described above can be performed. That is, the CPU 202 preferably flashes the import button 244, and when the import button 244 is operated, the CPU 202 writes the received image data on a virtual page in the RAM 206 and displays it on the display unit 210.

In the description above, a case was described in which the image display device 200 preferably is an electronic whiteboard device, but the present invention is not limited to this. The image display device 200 may be a projector device or may also be a multi-display device in which a large screen is formed by arranging a plurality of displays.

In the description above, a case was described in which image data preferably is sent to the image display device 200 as a file attached to an email, but the present invention is not limited to this. Image data (file) may also be sent to the image display device 200 from the terminal device 300, the image formation device 420, or the like via the network 410 in a method other than emails. For instance, if the image display device 200 has FTP or HTTP service capabilities, then the terminal device 300 or the image formation device 420 can send an image file to the image display device 200 directly (without attaching it to an email). In this case as well, when the image display device 200 receives image data, the image data can be processed in the same manner as described above.

The present invention was described above by describing various preferred embodiments, but the aforementioned preferred embodiments are just non-limiting examples, and the present invention can be implemented with various modifications without being limited to the aforementioned preferred embodiments.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image display device which displays images on at least one virtual page stored in a memory, the image display device comprising:
a display unit that displays images;
a virtual page controller arranged and programmed to configure the at least one virtual page in the memory and to store image data in the at least one virtual page;
a reception unit that receives data; and
an input unit that accepts a command to cause the display unit to display the data received by the reception unit as an image on the display unit; wherein
the virtual page controller includes a securing unit that secures in the memory a virtual page that contains no object and stores image data based on the data received by the reception unit on the virtual page that contains no object in response to receipt of the command by the input unit; and
the display unit displays as the image the image data written to the virtual page storing the image data based on the data received by the reception unit.

2. The image display device according to claim 1, further comprising a determination unit that determines, before the virtual page that contains no object is secured by the securing unit, whether or not the at least one virtual page configured by the virtual page controller contains an object to be displayed as an image by the display unit; wherein
the determination unit determines, in response to the receipt of the command by the input unit, whether or not the virtual page corresponding to the image that is on display on the display unit contains an object;
depending on a result of the determination by the determination unit, the virtual page controller is programmed to perform one of the following:
store image data based on the data received by the reception unit on the virtual page corresponding to the image that is on display;
store image data based on the data received by the reception unit on the virtual page corresponding to an image to be displayed following the image that is on display; or
store image data based on the data received by the reception unit on a virtual page newly secured by the securing unit as a region corresponding to an image to be displayed following the image that is on display.

3. The image display device according to claim 2, wherein in response to the determination by the determination unit that the virtual page corresponding to the image that is on display contains no object, the virtual page controller is programmed to store image data based on the data received by the reception unit on the virtual page corresponding to the image that is on display.

4. The image display device according to claim 2, wherein in response to the determination by the determination unit that the virtual page corresponding to the image that is on display contains an object and also the determination that the virtual page corresponding to the image following the image that is on display contains no object, the virtual page controller is programmed to store image data based on the data received by the reception unit on the virtual page corresponding to the image following the image that is on display.

5. The image display device according to claim 1, further comprising a determination unit that determines, before a virtual page that contains no object is secured by the securing unit, whether or not the configured virtual pages contain an object to be displayed as an image by the display unit; wherein
the determination unit determines, in response to the receipt of the command by the input unit, whether or not the virtual page corresponding to the image that is on display on the display unit contains an object; and
depending on a result of the determination by the determination unit regarding all of a plurality of the virtual pages, the virtual page controller is programmed to perform one of the following:
store image data based on the data received by the reception unit on the virtual page which stores data to be displayed as an image following the data to be displayed as an image at an end, out of the data stored on the virtual pages that have been determined to contain objects; or
store image data based on the data received by the reception unit on a virtual page newly secured by the securing unit, as a region to store data to be displayed as an image, following the data to be displayed as an image at an end, out of the data stored on the virtual pages that have been determined to contain objects.

6. The image display device according to claim 1, wherein in response to the data received by the reception unit containing a consolidation condition to consolidate and display a plurality of images in one page, the display unit displays image data based on the data received by the reception unit and to be displayed on the display unit as a plurality of pages of images on the display unit as images in accordance with the consolidation condition.

7. An image display system comprising:
the image display device according to claim 1; and
a portable terminal device that communicates with the image display device so as to send data to the image display device.

8. A method for controlling an image display device including a display unit that displays an image, a memory that stores data, and a reception unit that receives data, the method comprising:
a step of configuring virtual pages stored in the memory;
a step of accepting a command to cause the display unit to display data received by the reception unit as an image;
a step of securing in the memory a virtual page that contains no object;
a step of storing image data based on the data received by the reception unit on the virtual page that contains no object in response to receipt of the command; and
a step of displaying as the image the image data written to the virtual page storing the image data based on the data received by the reception unit.
